(19) United States
(12) Patent Application Publication
(10) Pub. No.: US 2017/0129078 A1
(43) Pub. Date: May 11, 2017

(54) WRENCH FOR EYE SOCKET FASTENER

(71) Applicant: C3, LLC, Upper Marlboro, MD (US)

(72) Inventor: Charles Gatling, Upper Marlboro, MD (US)

(73) Assignee: C3, LLC, Upper Marlboro, MD (US)

(21) Appl. No.: 15/413,967

(22) Filed: Jan. 24, 2017

Related U.S. Application Data
(60) Provisional application No. 62/399,876, filed on Sep. 26, 2016.

(51) Int. Cl. B25B 13/50; B25B 23/16; B25B 15/00

(52) U.S. Cl. CPC B25B 13/5091; B25B 15/008; B25B 23/16

(57) ABSTRACT

An eye bolt or screw eye wrench that engages an eye bolt or screw eye fastener, wherein the wrench includes a handle, a shank, and a wrench end. The handle allows ease of use with regard to rotation of an eye bolt or screw eye fastener, and the shank and wrench end provide a stable and secure contact surface and functionality for enacting the rotational force needed to secure these types of fasteners in place.

### CROSS-REFERENCE TO RELATED APPLICATIONS

This application claims the benefit of U.S. Provisional Application No. 62/399,876, filed on Sep. 26, 2016 and entitled “Wrench For Eye Socket Fastener,” the complete disclosure of which, in its entirety, is hereby incorporated by reference.

### BACKGROUND

Technical Field

The embodiments herein generally relate to a wrench, and more particularly to an eye bolt or screw eye wrench capable of engaging an eye bolt or screw eye fastener quickly and effectively.

Description of the Related Art

An eye bolt or screw eye are types of fasteners that require tools for engagement. However, these types of fasteners do not currently have a simple hand tool designated to engage such types of fasteners. Rather, there are complex ratcheting wrenches that may be used to engage an eye bolt or screw eye, and there exists a driver bit for this purpose, but it requires the use of a power drill. Other conventional wrenches include the tools described in U.S. Pat. Nos. 2,512,967; 2,530,914; and 2,753,743. Items that are commonly used to install eye bolts or screw eyes are any tools or objects that can be inserted into the eye of the eye bolt or screw eye that can enact rotational force by which to turn it, such as a screwdriver or awl. However, this is inefficient and does not provide easy or smooth rotational motion for engaging the eye bolt or screw eye. It is also ineffective in use as such objects may not provide a stable method for engaging the eye bolt or screw eye as they can become dislodged easily during use.

### SUMMARY

In view of the foregoing, an embodiment herein provides a wrench configured to engage an eye socket of an eye bolt or screw eye fastener, the wrench comprising a handle comprising a substantially curved configuration; a shank connected to the handle; and a knob-less, non-undulated wrench end connected to the shank, wherein any of the shank and the wrench end are configured to be inserted into the eye socket, and wherein the wrench end and the shank jointly provide a contact surface for engaging the eye bolt or screw eye fastener and enacting a sufficient rotational force on the eye bolt or screw eye fastener upon rotation of the handle. The handle may comprise a first substantially straight portion terminating in a flat surface; a second substantially straight portion; and a first bend connecting the first substantially straight portion to the second substantially straight portion. The first bend may form an approximately 90° angle between the first substantially straight portion and the second substantially straight portion. The first substantially straight portion may comprise a first longitudinal axis, wherein the second substantially straight portion may comprise a second longitudinal axis, and wherein the first longitudinal axis may be transverse to the second longitudinal axis. The wrench may further comprise a second bend, wherein the shank may comprise a third substantially straight portion, wherein the second bend may connect the shank to the wrench end, and wherein the wrench end may comprise a fourth substantially straight portion. The third substantially straight portion may be longer than the fourth substantially straight portion. The second bend may form an angle less than 90° between the third substantially straight portion and the fourth substantially straight portion. The angle may be approximately 60°. The third substantially straight portion may comprise the second longitudinal axis, wherein the fourth substantially straight portion may comprise a third longitudinal axis, and wherein the second longitudinal axis may be on a different plane than the third longitudinal axis. A thickness of the handle, the shank, and the wrench end may be substantially equal. An axis of rotation about the second bend may be parallel to the first longitudinal axis

Another embodiment provides a wrench comprising a first end comprising a pair of substantially straight portions connected by a first bend; a shank connected to the first end; a second bend connected to the shank; and a second end connected to the second bend, wherein an axis of rotation about the second bend is parallel to one of the substantially straight portions of the first end. The pair of substantially straight portions may comprise a first substantially straight portion terminating in a first tip, which may comprise a first substantially flat surface; and a second substantially straight portion, wherein the first bend connects the first substantially straight portion to the second substantially straight portion. The first bend may form an approximately 90° angle between the first substantially straight portion and the second substantially straight portion. The first substantially straight portion may comprise a first longitudinal axis, wherein the second substantially straight portion may comprise a second longitudinal axis, wherein the first longitudinal axis may be transverse to the second longitudinal axis, and wherein the axis of rotation about the second bend may be parallel to the first longitudinal axis. The shank may comprise a third substantially straight portion, wherein the second bend may connect the shank to the second end, and wherein the second end may comprise a fourth substantially straight portion terminating in a second tip, which may comprise a second substantially flat surface. The third substantially straight portion may be longer than the fourth substantially straight portion. The second bend may form an angle less than 90° between the third substantially straight portion and the fourth substantially straight portion. The angle may be approximately 60°. The third substantially straight portion may comprise the second longitudinal axis, wherein the fourth substantially straight portion may comprise a third longitudinal axis, and wherein the second longitudinal axis may be on a different plane than the third longitudinal axis. Any of the shank and the second end may be configured to be inserted into an eye socket of an eye bolt or screw eye fastener, wherein the second end and the shank may jointly provide a contact surface for engaging the eye bolt or screw eye fastener and enacting a sufficient rotational force on the eye bolt or screw eye fastener upon rotation of the first end.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a perspective view of a wrench according to an embodiment herein;

FIG. 2 illustrates a left-side elevational view of the wrench of FIG. 1 according to an embodiment herein;

FIG. 3 illustrates a right-side elevational view of the wrench of FIG. 1 according to an embodiment herein;

FIG. 4 illustrates a top view of the wrench of FIG. 1 according to an embodiment herein;

FIG. 5 illustrates a bottom view of the wrench of FIG. 1 according to an embodiment herein;

FIG. 6A illustrates a left-side elevational view of the wrench of FIG. 1 engaging an eye bolt or screw eye according to an embodiment herein;

FIG. 6B illustrates a right-side elevational view of the wrench of FIG. 1 engaging an eye bolt or screw eye according to an embodiment herein;

FIG. 7 is a cross-sectional view of the wrench of FIG. 1 according to a first embodiment herein;

FIG. 8 is a cross-sectional view of the wrench of FIG. 1 according to a second embodiment herein;

FIG. 9 is a cross-sectional view of the wrench of FIG. 1 according to a third embodiment herein; and

FIG. 10 is a schematic diagram of an eye bolt or screw eye fastener that may be engaged by the wrench of FIG. 1 according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

It will be understood that when an element or layer is referred to as being “on”, “connected to”, or “coupled to” another element or layer, it can be directly on, directly connected to, or directly coupled to the other element or layer, or intervening elements or layers may be present. In contrast, when an element or layer is referred to as being “directly on”, “directly connected to”, or “directly coupled to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

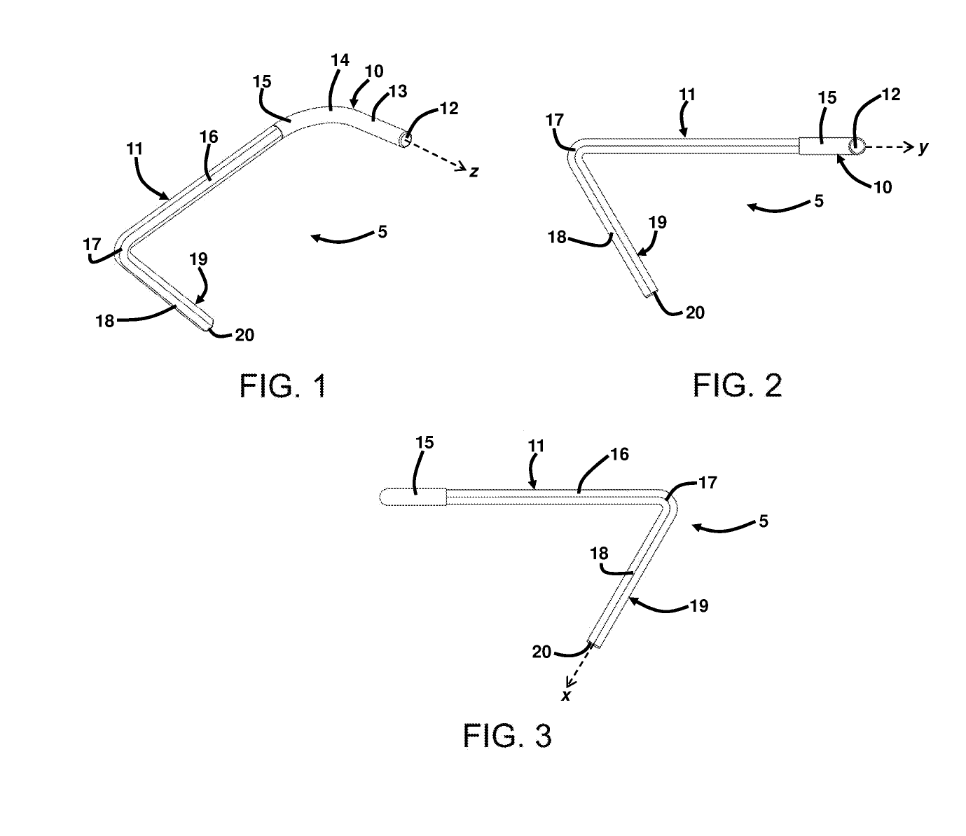

In the drawings, the size and relative sizes of components and regions may be exaggerated for clarity. The embodiments herein provide an eye bolt or screw eye wrench to overcome the problems of inefficient and ineffective conventional wrenches or other conventional tools used to engage an eye bolt or screw eye fastener. Referring now to the drawings, and more particularly to FIGS. 1 through 10, where similar reference characters denote corresponding features consistently throughout the figures, there are shown preferred embodiments.

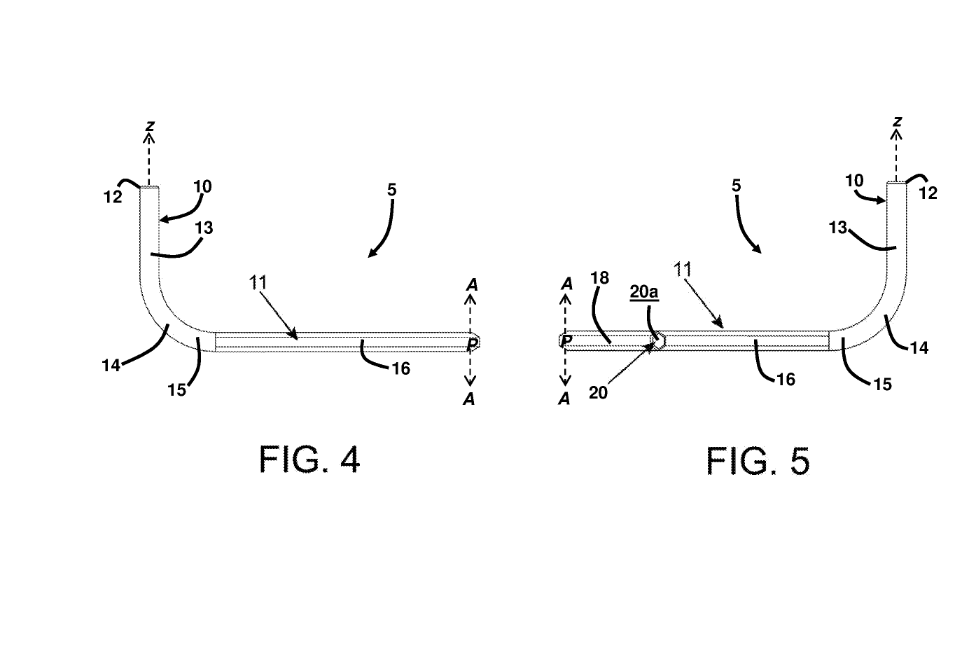

FIG. 1 is a perspective view of the eye bolt or screw eye wrench 5 in accordance with an embodiment herein. The wrench 5 comprises a handle 10, a shank 11, and a wrench end 19. The wrench end 19 engages the eye socket 26 of the eye bolt or screw eye (referred to herein as “fastener 25” as provided in the exemplary embodiment in FIG. 10) in a stable manner, and the handle 10 assists in rotating the fastener 25. FIGS. 2 and 3, with reference to FIG. 1, are left-side and right-side elevational views, respectively, of the eye bolt or screw eye wrench 5. FIGS. 4 and 5, with reference to FIGS. 1 through 3, are top-down and bottom-up views, respectively, of the eye bolt or screw eye wrench 5.

The handle 10 comprises a generally curved configuration comprising a first substantially straight portion 13 terminating in a tip 12. The handle 10 further includes a second substantially straight portion 15. The handle 10 does not require a sleeve or any other cover over the first or second substantially straight portions 13, 15 thereby allowing the wrench 5 to be constructed as a single component structure without having multiple parts and thereby reducing manufacturing complexities and reducing the chance for easily breakable components. The lack of sleeve or other cover also avoids the need for having a catch, cap, or other securing component over the tip 12 for sleeve/cover retention, which conventional wrenches typically require.

A bend 14 connects the first straight portion 13 to the second straight portion 15 such that the bend 14 creates an overall curved configuration for the handle 10, wherein the bend 14 forms an approximately 90° angle with respect to the first and second straight portions 13, 15 such that the axis z of the first straight portion 13 and the axis y of the second straight portion 15 are transversely positioned to one another on different planes. The shank 11 connects to the second straight portion 15 and comprises an elongated and substantially straight body portion 16. The second straight portion 15 of the handle 10 substantially aligns with the straight body portion 16 of the shank 11 such that they both align along the axis y.

A bend 17 connects the shank 11 to the wrench end 19, wherein the wrench end 19 comprises an elongated and substantially straight body portion 18 terminating in a tip 20. The substantially straight body portion 18 does not contain any curves, bumps, knobs, undulations, waves, etc., which facilitates ease of insertion of the fastener 25 through the wrench end 19. In one embodiment, the tips 12, 20 each comprise substantially flat surfaces 12a, 20a, respectively such that the flat surfaces 12a, 20a define a planar end tip 12, 20 (as opposed to a bulbous, angled, or pointed tip, etc.).

The straight body portion 16 of the shank 11 is configured to be longer than the straight body portion 18 of the wrench end 19 in one embodiment, although other configurations are possible. Moreover, the straight body portion 18 of the wrench end 19 is configured to be longer than the first straight portion 13 of the handle 10, although other configurations are possible. The wrench 5 is configured to have a substantially uniform thickness/diameter for the straight body portion 16 of the shank 11 as well as the straight body portion 18 of the wrench end 19. Moreover, the first and second straight portions 13, 15 of the handle 10 may also have the substantially same or just slightly greater thickness/diameter compared with the straight body portions 16, 18 of the shank 11 and wrench end 19, respectively. Such uniformity of the thickness/diameter of the various portions of the wrench 5 permit ease of handling, use, and manufacturing.

The bend 17 forms an angled configuration of the shank 11 in relation to the wrench end 19 such that the angle between the shank 11 and the wrench end 19 is less than 90° as best shown in FIGS. 2 and 3. In an exemplary embodiment, the bend 17 forms an approximately 60° angle (i.e., the angle between the shank 11 and the wrench end 19 is approximately 60°) although other angles are possible in accordance with the embodiments herein. Moreover, the axis x of the straight body portion 18 of the wrench end 19 is on a different plane from the axis z of the first straight portion 13 of the handle 10. Furthermore, the axis y of the second straight portion 15 is on a different plane from the axis x of the straight body portion 18 of the wrench end 19. Accordingly, the three axes (axis x, axis y, and axis z) are on different planes with respect to one another.

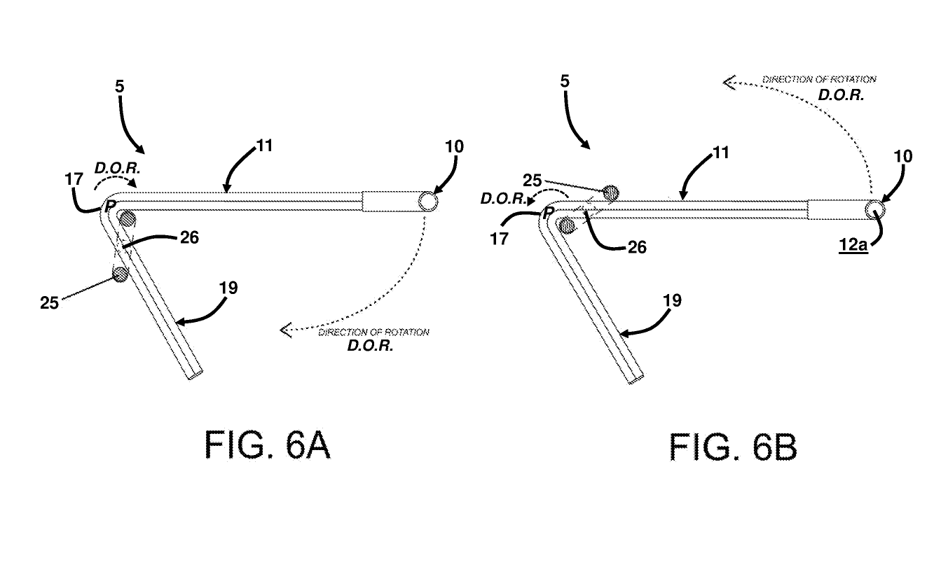

FIGS. 6A and 6B, with reference to FIGS. 1 through 5, are left-side elevational views of the eye bolt or screw eye wrench 5 displaying the wrench end 19 of the wrench 5 inserted into the eye socket 26 of the fastener 25 to illustrate positioning and direction of rotation for the fastener 25. The wrench end 19 is inserted through the eye socket 26 of the fastener 25 and depending on the direction of rotation of the wrench 5, either the shank 11 or the wrench end 19 rests in the eye socket 26 of the fastener 25 to facilitate rotation of the fastener 25. The bend 17, shank 11, and wrench end 19 collectively provide a stable and secure contact surface and functionality for enacting the required rotational force needed to secure fastener 25 in place.

More particularly, as shown in FIG. 6A, the wrench end 19 is positioned through the eye socket 26 of the fastener 25 until the fastener 25 reaches the bend 17 of the wrench 5 such that the shank 11 and the wrench end 19 maintain the position of the wrench 5 with respect to the fastener 25 and as the handle 10 of the wrench 5 is rotated, the wrench end 19 simultaneously rotates thereby rotating the fastener 25. This allows the fastener 25 to rotate in the direction indicated in FIG. 6A without the fastener 25 slipping and to allow the wrench 5 to maintain a proper engagement with the fastener 25.

FIG. 6A depicts the fastener 25 being rotated in a first direction (e.g., being screwed/inserted into an object (not shown)). FIG. 6B depicts the fastener 25 being rotated in a second direction (e.g., being unscrewed/retracted from an object (not shown)). The view of FIG. 6B shows the fastener 25 held into position by the shank 11 and wrench end 19 at the bend 17. However, this positioning occurs upon rotation of the handle 10 in the direction indicated in FIG. 6B, wherein regardless of the ultimate direction of rotation of the wrench 5, the wrench end 19 is initially inserted through the eye socket 26 of the fastener 25 to initially seat the wrench 5 into the eye socket 26 of the fastener 25. Once the handle 10 is rotated in the direction indicated in FIG. 6B, the position of the fastener 25 with respect to the shank 11 and the wrench end 19 changes from its initial position depicted in FIG. 6A to the position depicted in FIG. 6B. Should the direction of rotation change again, then the position of the fastener 25 with respect to the shank 11 and the wrench end 19 will once again change to the initial position as depicted in FIG. 6A. The position of the fastener 25 with respect to the shank 11 and the wrench end 19 allows the fastener 25 to rotate in the direction indicated in FIG. 6B without the fastener 25 slipping and to allow the wrench 5 to maintain a proper engagement with the fastener 25.

Accordingly, the handle 10 is engaged by a user to rotate the wrench 5 such that the direction of rotation (D.O.R.) may occur either clockwise or counter-clockwise. In this regard, the angular rotation (clockwise or counter-clockwise) of the wrench 5 occurs with respect to (about) point P, which occurs at bend 17, as indicated in FIGS. 4 through 6B such that the axis of rotation (A) is an axis extending through point P, wherein the axis of rotation (A) is parallel to axis z of the first straight portion 13 of the handle 10.

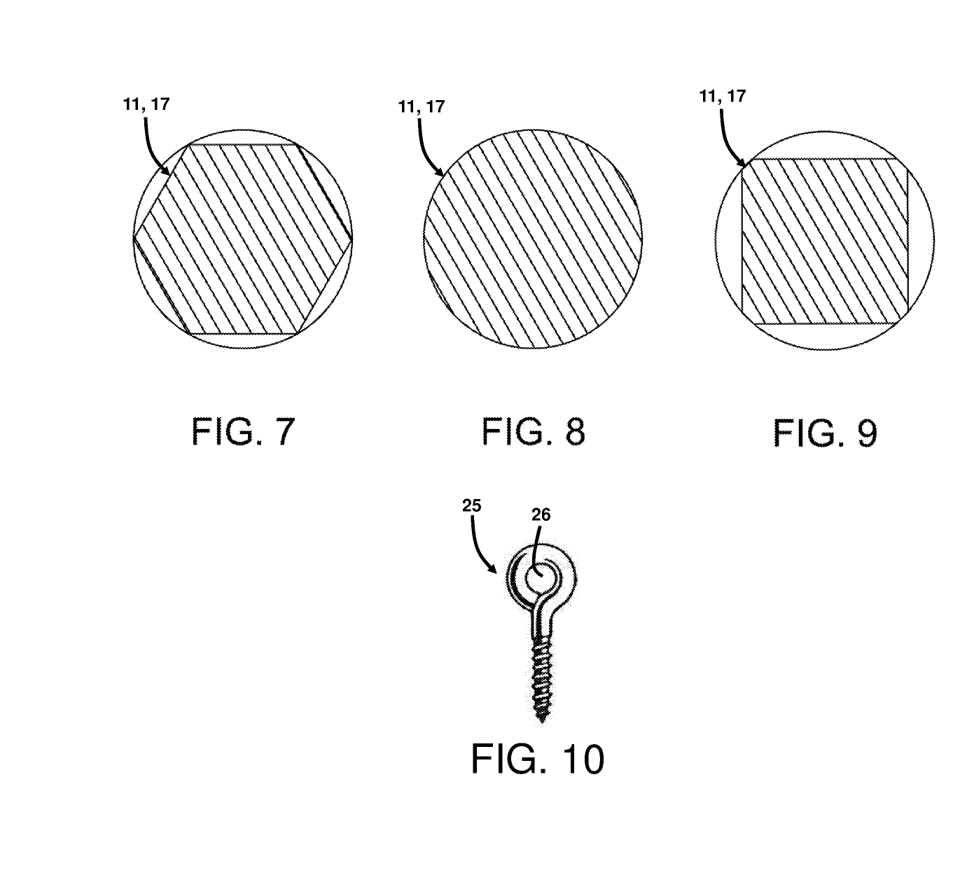

FIGS. 7 through 9, with reference to FIGS. 1 through 6B, are enlarged cross-sectional views of any of the shank 11 and wrench end 19 of the eye bolt or screw eye wrench 5 in accordance with the embodiments herein. FIG. 7 illustrates a polygonal configuration. FIG. 8 illustrates a curved configuration. FIG. 9 illustrates another polygonal configuration. FIGS. 7 through 9 are shown as exemplary configurations of any of the shank 11 and wrench end 19. However, the embodiments herein are not restricted to these or any other particular geometric configuration. FIG. 10, with reference to FIGS. 1 through 9, is a schematic diagram of an exemplary fastener 25 that may be engaged by the wrench 5 according to an embodiment herein. The fastener 25 is shown comprising an eye socket 26 through which any of the shank 11 and the wrench end 19 is inserted.

The wrench 5 is dimensioned and configured to be able to engage all standard sizes, shapes, and configurations of fastener 25 used in the industry. However, during manufacturing, the wrench 5 may be appropriately configured (e.g., designed, lengthened, thickened, sized, etc.) according to particular requirements or sizes of fastener 25, and the embodiments herein are not restricted to a particular length, thickness, size, or material of the wrench 5.

The embodiments herein provide an eye bolt or screw eye wrench 5 capable of efficiently and effectively engaging eye bolt and screw eye fasteners 25. The wrench comprises a handle (e.g., first end) 10, a shank 11, and a wrench end (e.g., second end) 19. The handle 10 allows ease of use with regard to rotation of an eye bolt or screw eye fastener 25, and the shank 11 and wrench end 19 provide a stable and secure contact surface and functional design for enacting the rotational force needed to secure the fastener 25 in place.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A wrench configured to engage an eye socket of an eye bolt or screw eye fastener, said wrench comprising:
a handle comprising a substantially curved configuration;
a shank connected to said handle; and
a knob-less, non-undulated wrench end connected to said shank,
wherein any of said shank and said wrench end are configured to be inserted into said eye socket, and
wherein said wrench end and said shank jointly provide a contact surface for engaging said eye bolt or screw eye fastener and enacting a sufficient rotational force on said eye bolt or screw eye fastener upon rotation of said handle.

2. The wrench of claim 1, wherein said handle comprises:
a first substantially straight portion terminating in a flat surface;
a second substantially straight portion; and
a first bend connecting said first substantially straight portion to said second substantially straight portion.

3. The wrench of claim 2, wherein said first bend forms an approximately 90° angle between said first substantially straight portion and said second substantially straight portion.

4. The wrench of claim 2, wherein said first substantially straight portion comprises a first longitudinal axis, wherein said second substantially straight portion comprises a second longitudinal axis, and wherein said first longitudinal axis is transverse to said second longitudinal axis.

5. The wrench of claim 4, further comprising:
a second bend,
wherein said shank comprises a third substantially straight portion,
wherein said second bend connects said shank to said wrench end, and
wherein said wrench end comprises a fourth substantially straight portion.

6. The wrench of claim 5, wherein said third substantially straight portion is longer than said fourth substantially straight portion.

7. The wrench of claim 5, wherein said second bend forms an angle less than 90° between said third substantially straight portion and said fourth substantially straight portion.

8. The wrench of claim 7, wherein said angle is approximately 60°.

9. The wrench of claim 5, wherein said third substantially straight portion comprises said second longitudinal axis, wherein said fourth substantially straight portion comprises a third longitudinal axis, and wherein said second longitudinal axis is on a different plane than said third longitudinal axis.

10. The wrench of claim 5, wherein an axis of rotation about said second bend is parallel to said first longitudinal axis.

11. A wrench comprising:
a first end comprising a pair of substantially straight portions connected by a first bend;
a shank connected to said first end;
a second bend connected to said shank; and
a second end connected to said second bend,
wherein an axis of rotation about said second bend is parallel to one of the substantially straight portions of said first end.

12. The wrench of claim 11, wherein said pair of substantially straight portions comprises a first substantially straight portion terminating in a first tip comprising a first substantially flat surface; and a second substantially straight portion, wherein said first bend connects said first substantially straight portion to said second substantially straight portion.

13. The wrench of claim 12, wherein said first bend forms an approximately 90° angle between said first substantially straight portion and said second substantially straight portion.

14. The wrench of claim 12, wherein said first substantially straight portion comprises a first longitudinal axis, wherein said second substantially straight portion comprises a second longitudinal axis, wherein said first longitudinal axis is transverse to said second longitudinal axis, and wherein said axis of rotation about said second bend is parallel to said first longitudinal axis.

15. The wrench of claim 12, wherein said shank comprises a third substantially straight portion, wherein said second bend connects said shank to said second end, and wherein said second end comprises a fourth substantially straight portion terminating in a second tip comprising a second substantially flat surface.

16. The wrench of claim 15, wherein said third substantially straight portion is longer than said fourth substantially straight portion.

17. The wrench of claim 15, wherein said second bend forms an angle less than 90° between said third substantially straight portion and said fourth substantially straight portion.

18. The wrench of claim 17, wherein said angle is approximately 60°.

19. The wrench of claim 15, wherein said third substantially straight portion comprises said second longitudinal axis, wherein said fourth substantially straight portion comprises a third longitudinal axis, and wherein said second longitudinal axis is on a different plane than said third longitudinal axis.

20. The wrench of claim 11, wherein any of said shank and said second end are configured to be inserted into an eye socket of an eye bolt or screw eye fastener, and wherein said second end and said shank jointly provide a contact surface for engaging said eye bolt or screw eye fastener and enacting a sufficient rotational force on said eye bolt or screw eye fastener upon rotation of said first end.
